(19) United States
(12) Patent Application Publication
(10) Pub. No.: US 2025/0260188 A1
(43) Pub. Date: Aug. 14, 2025

(54) TERMINAL

(71) Applicant: YAZAKI CORPORATION, Tokyo (JP)

(72) Inventors: Noboru Hayasaka, Makinohara-shi (JP); Shintaro Yagi, Makinohara-shi (JP); Kenshiro Shigemoto, Makinohara-shi (JP); Masayuki Ishigami, Fujieda-shi (JP)

(21) Appl. No.: 19/009,908

(22) Filed: Jan. 4, 2025

(30) Foreign Application Priority Data
Feb. 8, 2024 (JP) 2024-017551

(51) Int. Cl. H01R 13/11; H01R 4/48

(52) U.S. Cl. CPC H01R 13/111; H01R 4/48185

(57) ABSTRACT

A terminal includes a terminal connection unit into which a counterpart terminal is inserted. The terminal connection unit includes an inner circumferential wall that includes a slit and an insertion space, folded units that are folded and bent outward in a radial direction, and outer circumferential walls that are formed in an elastically deformable. The inner circumferential wall includes through-holes that penetrate in the radial direction. The outer circumferential walls include outer circumferential wall contacts that protrude to the insertion space through the through-holes. In an insertion state, the outer circumferential wall contacts come into contact with the counterpart terminal, and press the counterpart terminal due to elastic deformation of the outer circumferential walls.

### CROSS-REFERENCE TO RELATED APPLICATION(S)

The present application claims priority to and incorporates by reference the entire contents of Japanese Patent Application No. 2024-017551 filed in Japan on Feb. 8, 2024.

### BACKGROUND OF THE INVENTION

### 1. Field of the Invention

The present invention relates to a terminal.

### 2. Description of the Related Art

Some terminals include a terminal body that has a cylindrical shape and into which an electric contactor is inserted, and an elastic contact member that is housed in the terminal body, has a cylindrical shape, and applies contact pressure to the electric contactor (see, for example, Japanese Patent Application Laid-open No. 2018-195439).

Meanwhile, some conventional terminals are constituted by the terminal body and the elastic contact member, and therefore there is room for improvements in terms of a reduction in the number of parts.

### SUMMARY OF THE INVENTION

It is an object of the present invention to provide a terminal that can achieve a reduction in the number of parts.

In order to achieve the above mentioned object, a terminal according to one aspect of the present invention includes a terminal connection unit that is formed into a tubular shape in an axial direction, a counterpart terminal being inserted into the terminal connection unit from one opening toward another opening, the terminal connection unit being electrically connected to the counterpart terminal, wherein the terminal connection unit includes: an inner circumferential wall that has the tubular shape, and includes a slit that is formed in the axial direction, and an insertion space that communicates with an outside through the slit, the counterpart terminal being inserted into the insertion space from the one opening; a folded unit that is formed at each of slit side ends in a circumferential direction around an axis of the inner circumferential wall, the folded unit being folded and bent outward in a radial direction that is orthogonal to the axial direction; and an outer circumferential wall that extends in the circumferential direction along the inner circumferential wall from the folded unit, the outer circumferential wall being formed in an elastically deformable manner to be separated from the inner circumferential wall with the folded unit as a fulcrum, the inner circumferential wall includes at least one through-hole that penetrates the inner circumferential wall in the radial direction, the outer circumferential wall includes at least one outer circumferential wall contact that is formed to protrude to the insertion space through the through-hole, and the outer circumferential wall contact performs coming into contact with the counterpart terminal and pressing the counterpart terminal due to elastic deformation of the outer circumferential wall, in an insertion state where the counterpart terminal has been inserted into the terminal connection unit.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective view illustrating a schematic configuration of a terminal according to an embodiment;

FIG. 2 is a view illustrating the terminal according to the embodiment when viewed in an axial direction;

FIG. 3 is a view illustrating a terminal connection unit of the terminal according to the embodiment when viewed from a lower side;

FIG. 4 is a sectional view in an arrow direction of line A-A of FIG. 3;

FIG. 5 is a perspective view illustrating a schematic configuration of a terminal according to a first variation of the embodiment;

FIG. 6 is a view illustrating the terminal according to the first variation of the embodiment when viewed in an axial direction;

FIG. 7 is a view illustrating a terminal connection unit of the terminal according to the first variation of the embodiment when viewed from a lower side;

FIG. 8 is a sectional view in an arrow direction of line B-B of FIG. 7;

FIG. 9 is a view illustrating a change in a state of the terminal according to the first variation of the embodiment;

FIG. 10 is a perspective view illustrating a schematic configuration of a terminal according to a second variation of the embodiment;

FIG. 11 is a view illustrating the terminal according to the second variation of the embodiment when viewed in the axial direction;

FIG. 12 is a view illustrating a terminal connection unit of the terminal according to the second variation of the embodiment when viewed from a lower side; and

FIG. 13 is a sectional view in an arrow direction of line C-C of FIG. 12.

### DETAILED DESCRIPTION OF THE PREFERRED EMBODIMENTS

An embodiment according to the present invention is described in detail below with reference to the drawings. Note that the embodiment described below is not restrictive of the present invention. Stated another way, components according to the embodiment described below include components that those skilled in the art could easily conceive of or substantially the same components, and various omissions, replacements, or changes can be made without departing from the gist of the invention.

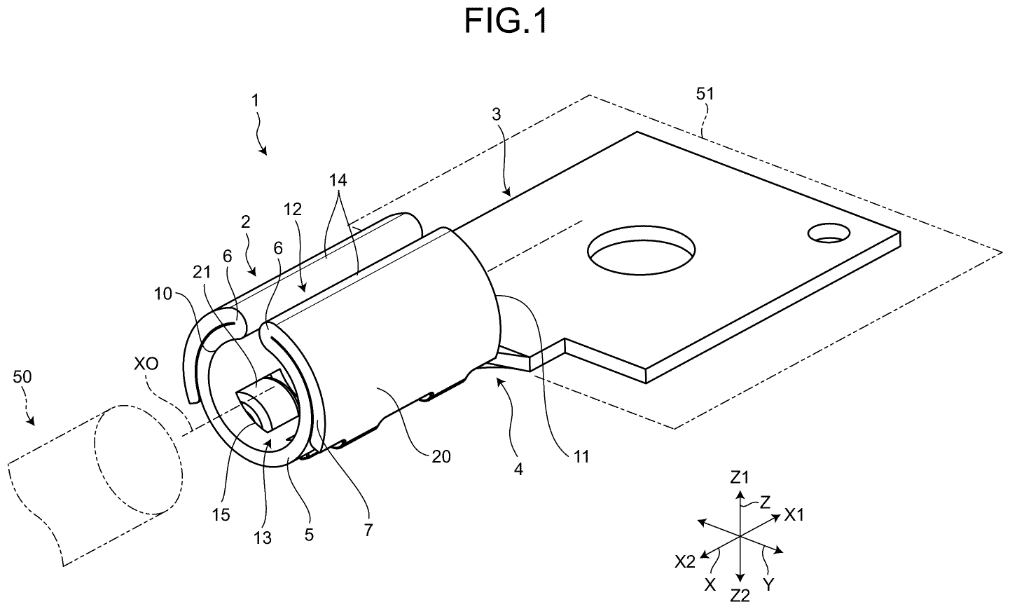

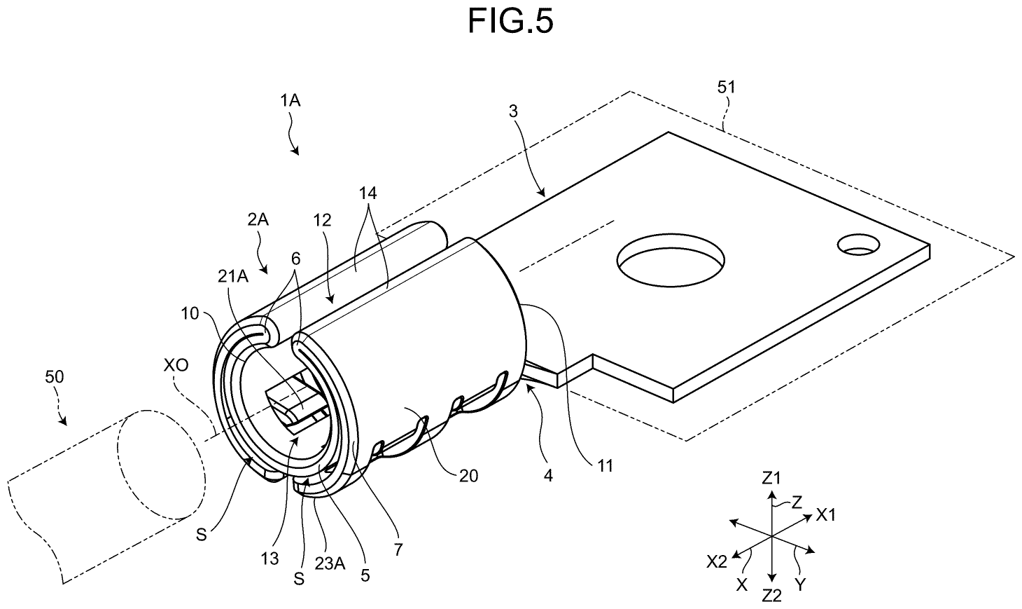

Note that in the description below, for convenience's sake, it is assumed that an X-direction illustrated in FIGS. 1 to 4 (including FIGS. 5 to 13) is an “axial direction X”, a Y-direction is a “width direction Y”, and a Z-direction is a “height direction Z”. The axial direction X, the width direction Y, and the height direction Z are orthogonal to each other. The axial direction X corresponds to, for example, an extending direction of a terminal, an insertion/removal direction of a counterpart terminal, or the like. Here, it is assumed that one direction of the axial direction X is an insertion direction X1 of a counterpart terminal 50, and another direction is a removal direction X2 of the counterpart terminal 50. Furthermore, it is assumed that one direction of the height direction Z is a first direction Z1, and another direction is a second direction Z2. Note that respective directions to be used in the description below are described as directions in a state where a terminal 1 has been fixed to equipment 51, unless otherwise specified.

### Embodiment

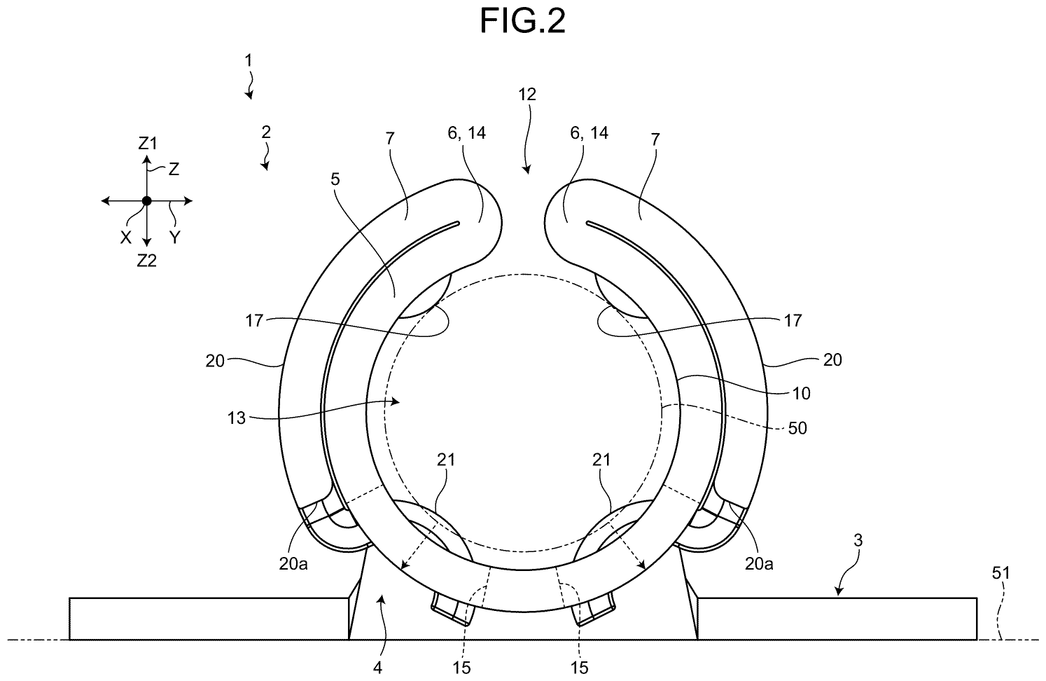

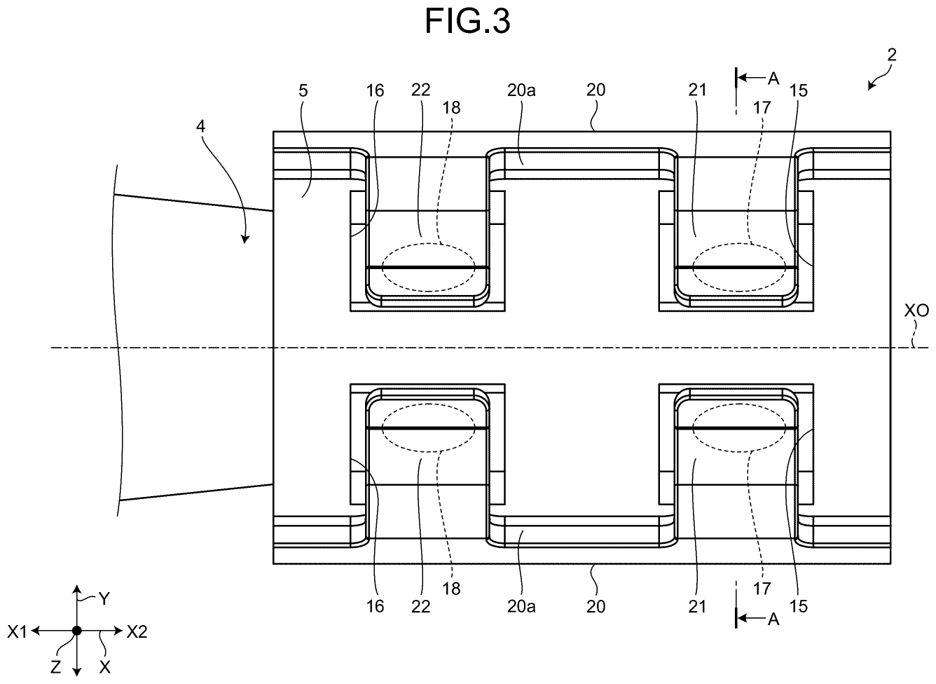

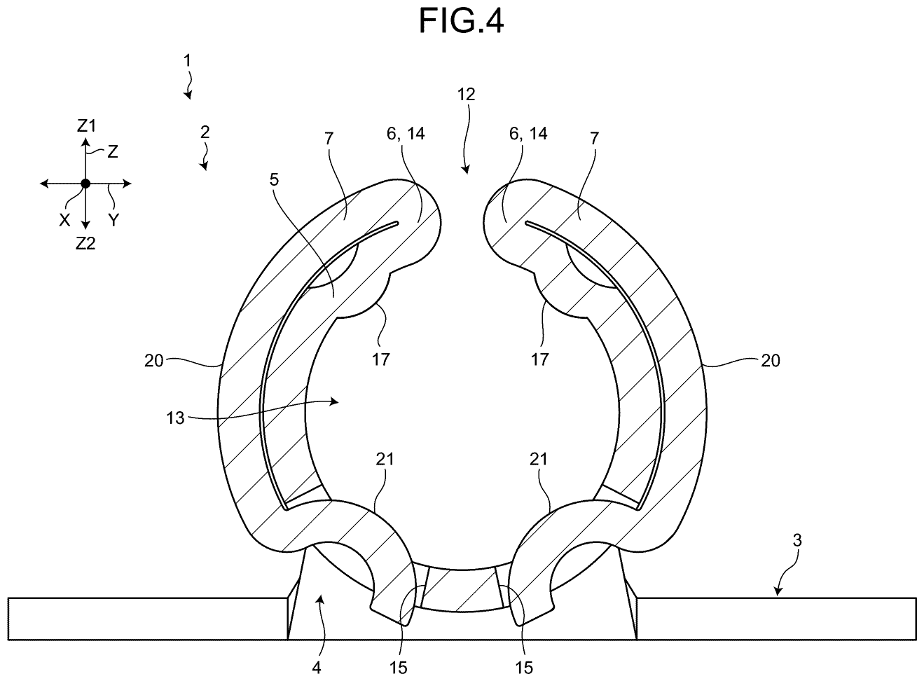

FIG. 1 is a perspective view illustrating a schematic configuration of a terminal according to an embodiment. FIG. 2 is a view illustrating the terminal according to the embodiment when viewed in an axial direction. FIG. 3 is a view illustrating a terminal connection unit of the terminal according to the embodiment when viewed from a lower side. FIG. 4 is a sectional view in an arrow direction of line A-A of FIG. 3.

The terminal 1 is mounted on, for example, the equipment 51 equipped in a vehicle, as illustrated in FIG. 1, and is connected to the counterpart terminal 50, and therefore the terminal 1 electrically connects the counterpart terminal 50 to the equipment 51. The counterpart terminal 50 is formed into a columnar shape, and is constituted by a conductive metal member.

The terminal 1 is constituted by, for example, a conductive metal material the entirety of which is integrally formed. For example, various types of processing, such as punching, press working, or folding, are performed on a single metal plate in accordance with shapes that correspond to respective units, such as a terminal connection unit 2, an equipment fixing unit 3, or a coupler 4, to mold the terminal 1, and therefore the respective units are formed three-dimensionally and integrally. In the terminal 1, the terminal connection unit 2, the coupler 4, and the equipment fixing unit 3 are coupled to each other in this order from a side in the removal direction X2 to a side in the insertion direction X1 in the axial direction X.

The terminal connection unit 2 is formed into a cylindrical shape in the axial direction X as a whole, as illustrated in FIG. 1. The counterpart terminal 50 is inserted into the terminal connection unit 2 from one opening 10 toward another opening 11, and the terminal connection unit 2 is electrically connected to the counterpart terminal 50. The terminal connection unit 2 is constituted by an inner circumferential wall 5, two folded units 6, and two outer circumferential walls 7.

The inner circumferential wall 5 is formed into a cylindrical shape in the axial direction X, and is coupled to each of the outer circumferential walls 7 via each of the folded units 6, as illustrated in FIGS. 1, 2, and 4. The inner circumferential wall 5 includes a slit 12, an insertion space 13, four through-holes 15, 15, 16, and 16, and four inner circumferential wall contacts 17, 17, 18, and 18.

The slit 12 is a clearance that is linearly formed in the axial direction X of the terminal connection unit 2. The slit 12 is formed by a pair of folded units 6 that face each other in a circumferential direction around an axis XO of the inner circumferential wall 5. The slit 12 is formed to penetrate from one opening 10 to the other opening 11 of the inner circumferential wall 5, and causes the insertion space 13 to communicate with an external space.

The insertion space 13 is a portion that is formed by the inner circumferential wall 5, and communicates with the outside via the slit 12, and into which the counterpart terminal 50 is inserted from the one opening 10. The insertion space 13 is formed between a pair of openings 10 and 11 that face each other in the axial direction X.

The through-holes 15, 15, 16, and 16 are through-holes that penetrate the inner circumferential wall 5 in a radial direction that is orthogonal to the axial direction X, as illustrated in FIGS. 1 to 3. The two through-holes 15 and 15 are formed on a side in the removal direction X2, and the two through-holes 16 and 16 are formed on a side in the insertion direction X1. All of the four through-holes 15, 15, 16, and 16 are formed into a rectangular shape when viewed in the height direction z.

Each of the inner circumferential wall contacts 17, 17, 18, and 18 is a portion that is formed to protrude from an inner circumferential face of the inner circumferential wall 5 toward the insertion space 13, and comes into contact with the counterpart terminal 50 in an insertion state where the counterpart terminal 50 has been inserted into the terminal connection unit 2. The two inner circumferential wall contacts 17 and 17 are provided on a side in the removal direction X2 of the inner circumferential wall 5, and are formed in positions that are symmetrical in the width direction Y with the axis XO as a central axis when viewed in the height direction Z. The two inner circumferential wall contacts 18 and 18 are provided on a side in the insertion direction X1 of the inner circumferential wall 5, and are formed in positions that are symmetrical in the width direction Y with the axis XO as a central axis when viewed in the height direction Z.

All of the inner circumferential wall contacts 17, 17, 18, and 18 are formed into a convex shape in such a way that a sectional shape when viewed in the axial direction X is curved to expand from the inner circumferential face of the inner circumferential wall 5 toward the insertion space 13, as illustrated in FIG. 4. The inner circumferential wall contacts 17, 17, 18, and 18 are formed to have, for example, a roughly semicircular sectional shape when viewed in the axial direction X. All of the inner circumferential wall contacts 17, 17, 18, and 18 come into point contact with the counterpart terminal 50 in the insertion state where the counterpart terminal 50 has been inserted into the terminal connection unit 2.

The folded units 6 are portions that are formed at slit side ends 14 in the circumferential direction around the axis XO of the inner circumferential wall 5, and are folded and bent outward in the radial direction. The folded units 6 according to the present embodiment have a slight clearance inside in the illustrated example, but are bent in such a way that the inner circumferential wall 5 and the outer circumferential walls 7 overlap each other in the radial direction.

The outer circumferential walls 7 are portions that are formed in an elastically deformable manner to extend in the circumferential direction along the inner circumferential wall 5 from the respective folded units 6, and be separated from the inner circumferential wall 5 with the respective folded units 6 as a fulcrum. The outer circumferential walls 7 face the inner circumferential wall 5 in the radial direction, and are located outside in the radial direction. The outer circumferential walls 7 include outer circumferential wall bodies 20 and four outer circumferential wall contacts 21, 21, 22, and 22.

The outer circumferential wall body 20 is formed along the inner circumferential wall 5 in the circumferential direction from the folded unit 6, and is formed to cover a portion of an outer circumferential face of the inner circumferential wall 5.

The outer circumferential wall contacts 21, 21, 22, and 22 are portions that are provided on the inner circumferential wall 5, are formed to protrude to the insertion space 13 through the though-holes 15, 15, 16, and 16 that face each other in the radial direction, and come into contact with the counterpart terminal 50 in the insertion state where the counterpart terminal 50 has been inserted into the terminal connection unit 2. Each of the outer circumferential wall contacts 21, 21, 22, and 22 is formed to protrude from an end 20a in the circumferential direction of the outer circumferential wall body 20. The two outer circumferential wall contacts 21 and 21 are provided on a side in the removal direction X2 of the outer circumferential walls 7, and are formed in positions that are symmetrical in the width direction Y with the axis XO as a central axis when viewed in the height direction Z. The two outer circumferential wall contacts 22 and 22 are provided on a side in the insertion direction X1 of the outer circumferential walls 7, and are formed in positions that are symmetrical in the width direction Y with the axis XO as a central axis when viewed in the height direction Z.

All of the outer circumferential wall contacts 21, 21, 22, and 22 are formed into a convex shape or an inverted U-shape in such a way that a sectional shape when viewed in the axial direction X is curved to expand toward the insertion space 13, as illustrated in FIG. 4. The outer circumferential wall contacts 21, 21, 22, and 22 come into contact with the counterpart terminal 50, and press the counterpart terminal 50 due to elastic deformation of the outer circumferential walls 7, in the insertion state where the counterpart terminal 50 has been inserted into the terminal connection unit 2. All of the outer circumferential wall contacts 21, 21, 22, and 22 come into line contact with the counterpart terminal 50 in the axial direction X in the insertion state described above.

When viewed in the axial direction X in a non-insertion state where the counterpart terminal 50 has not been inserted into the terminal connection unit 2, portions of the outer circumferential wall contacts 21 and 21 are inserted into the through-holes 15 and 15, and portions that will come into contact with the counterpart terminal 50 protrude from the inner circumferential face of the inner circumferential wall 5 to a side of the insertion space 13. When viewed in the axial direction X in the non-insertion state described above, portions of the outer circumferential wall contacts 22 and 22 are inserted into the through-holes 16 and 16, and portions that will come into contact with the counterpart terminal 50 protrude from the inner circumferential face of the inner circumferential wall 5 to a side of the insertion space 13.

The equipment fixing unit 3 is a portion that fixes the terminal 1 to the equipment 51. The equipment fixing unit 3 is formed into a flat rectangular shape, and includes some through-holes into which a fastening member such as a bolt is inserted.

The coupler 4 is a portion that couples the equipment fixing unit 3 and the inner circumferential wall 5.

As described above, the terminal 1 according to the present embodiment includes the terminal connection unit 2 into which the counterpart terminal 50 is inserted and that is electrically connected to the counterpart terminal 50. The terminal connection unit 2 includes the inner circumferential wall 5 that has a tubular shape, and includes the slit 12 that is formed in the axial direction X and the insertion space 13 into which the counterpart terminal 50 is inserted, the folded units 6 that are folded and bent outward in the radial direction that is orthogonal to the axial direction X, and the outer circumferential walls 7 that are formed in an elastically deformable manner to be separated from the inner circumferential wall 5 with the folded units 6 as a fulcrum. The inner circumferential wall 5 includes the through-holes 15 and 16 that penetrate in the radial direction. The outer circumferential walls 7 include the outer circumferential wall contacts 21 that protrude to the insertion space 13 through the through-holes 15 and 16. In the insertion state, the outer circumferential wall contacts 21 come into contact with the counterpart terminal 50, and press the counterpart terminal 50 due to elastic deformation of the outer circumferential walls 7.

In the terminal 1, when the counterpart terminal 50 has been inserted into the insertion space 13 from the opening 10 of the terminal connection unit 2, an outer circumferential face of the counterpart terminal 50 abuts onto the inner circumferential wall contacts 17 and 17 and the outer circumferential wall contacts 21 and 21. Then, when the counterpart terminal 50 has moved in the insertion direction X1, the counterpart terminal 50 presses the inner circumferential wall contacts 17 and 17, each of the inner circumferential walls 5 elastically deforms outward in the radial direction together with each of the outer circumferential walls 7, by using, as a fulcrum, a portion that faces the slit 12 in the radial direction, and the slit 12 becomes relatively wider in the radial direction. Simultaneously, the counterpart terminal 50 presses the outer circumferential wall contacts 21 and 21, and each of the outer circumferential walls 7 elastically deforms outward in the radial direction with the folded units 6 as a fulcrum. Then, when a distal end of the counterpart terminal 50 has moved to a side of the opening 11, the inner circumferential wall contacts 18 and 18 and the outer circumferential wall contacts 22 and 22 come into contact with the outer circumferential face of the counterpart terminal 50. When the counterpart terminal 50 has been completely inserted into the terminal connection unit 2, the outer circumferential wall contacts 21, 21, 22, and 22 press the counterpart terminal 50 due to the elastic force of each of the outer circumferential walls 7, and the inner circumferential wall contacts 17, 17, 18, and 18 press the counterpart terminal 50 due to the elastic force of each of the inner circumferential walls 5, and therefore the counterpart terminal 50 is held by the terminal 1. At this time, the counterpart terminal 50 is made conductive to the terminal 1 due to contact of the outer circumferential face of the counterpart terminal 50 with the inner circumferential wall contacts 17, 17, 18, and 18 and the outer circumferential wall contacts 21, 21, 22, and 22, and the counterpart terminal 50 is electrically connected to the terminal 1.

Furthermore, in a state where the counterpart terminal 50 has been completely inserted into the terminal connection unit 2, in a case where an axis of the counterpart terminal 50 deviates in a direction that is orthogonal to the axial direction X, the terminal 1 operates to cause the counterpart terminal 50 to return to an original position due to the elastic force of each of the inner circumferential walls 5 and the elastic force of each of the outer circumferential walls 7. This enables the terminal 1 to easily prevent the axis of the counterpart terminal 50 from deviating.

In the terminal 1, the configuration described above enables a terminal body to be provided with a function of an elastic contact member in comparison with a conventional terminal, and therefore it is sufficient if only the terminal body is used, the elastic contact member can be omitted, and a reduction in the number of parts of the terminal can be achieved.

Furthermore, in the terminal 1 according to the present embodiment, the inner circumferential wall 5 is coupled to the outer circumferential walls 7 via the folded units 6, and therefore even if the thickness of the terminal 1 is set to be smaller than the thickness of a conventional terminal, a certain volume of the entirety of the terminal can be secured, and conductor resistance can be made less likely to increase.

Furthermore, in the terminal 1 according to the present embodiment, the terminal connection unit 2 is formed into a cylindrical shape to correspond to the counterpart terminal 50 that is formed into a columnar shape or a cylindrical shape. Moreover, the inner circumferential wall 5 includes four inner circumferential wall contacts 17, 17, 18, and 18 that protrude toward the insertion space 13, are formed in positions that face the outer circumferential wall contacts 21, 21, 22, and 22 in the radial direction across the axis XO in the axial direction X, and come into contact with the counterpart terminal 50 in the insertion state described above. Therefore, in the terminal 1, the outer circumferential wall contacts 21, 21, 22, and 22 and the inner circumferential wall contacts 17, 17, 18, and 18 can come into contact with the counterpart terminal 50 from both sides in the radial direction, and pressing balance can be secured between contacts that face each other in the radial direction.

### First Variation

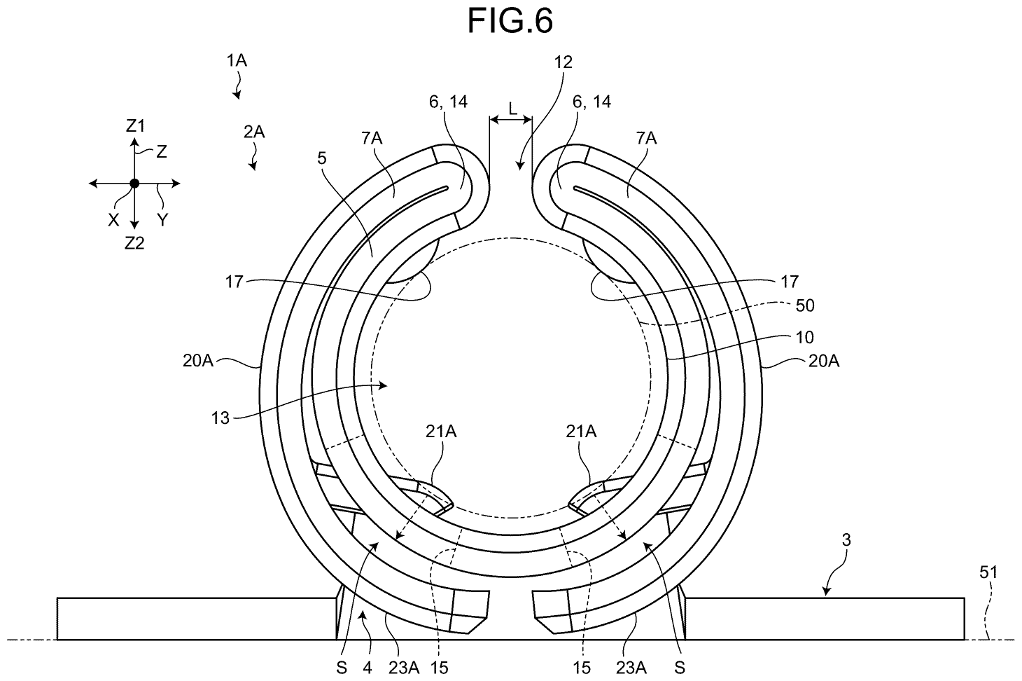

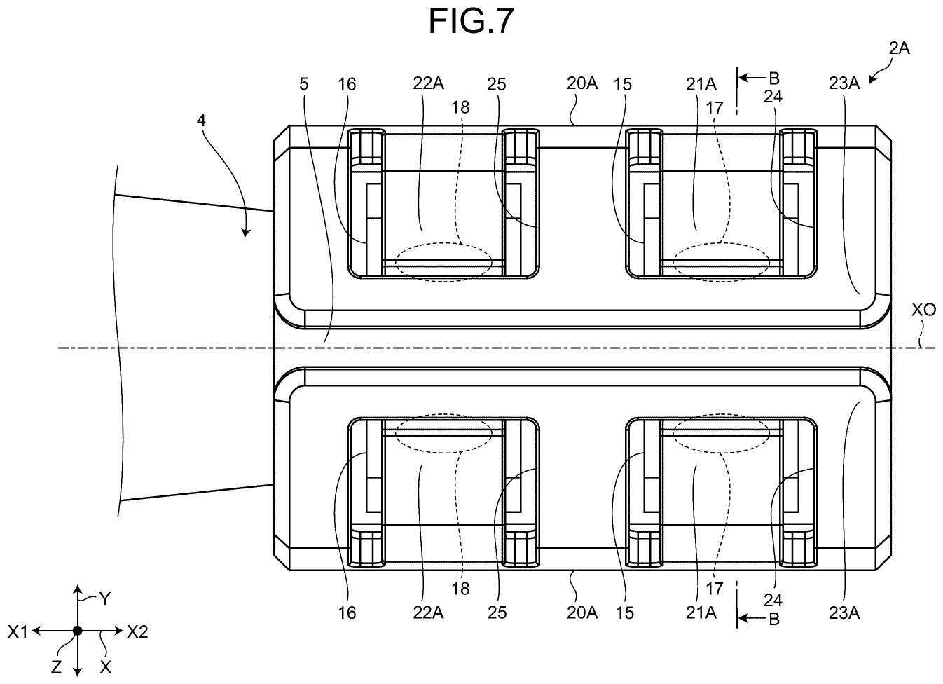

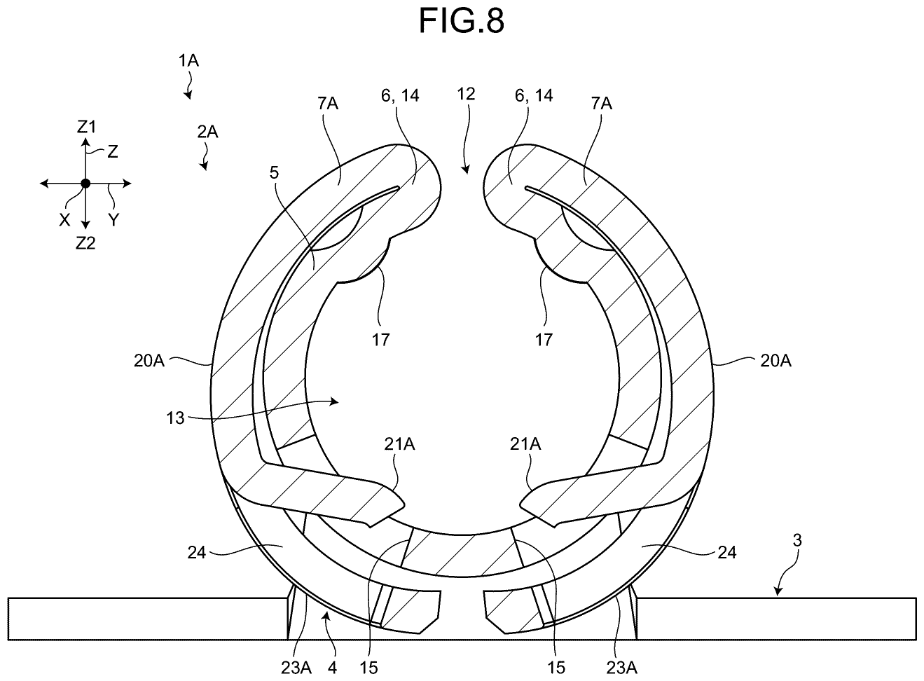

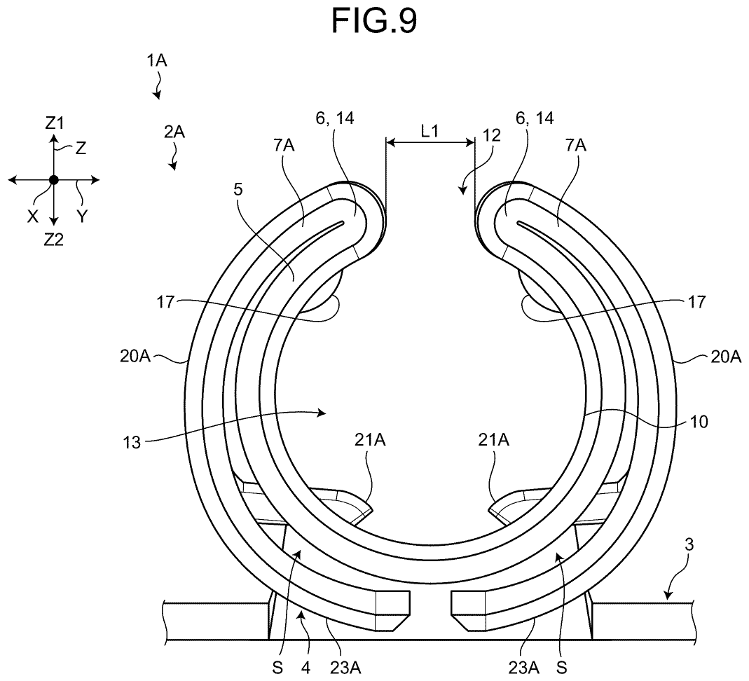

Next, a terminal 1A according to a first variation of the embodiment is described with reference to FIGS. 5 to 9. FIG. 5 is a perspective view illustrating a schematic configuration of a terminal according to the first variation of the embodiment. FIG. 6 is a view illustrating the terminal according to the first variation of the embodiment when viewed in an axial direction. FIG. 7 is a view illustrating a terminal connection unit of the terminal according to the first variation of the embodiment when viewed from a lower side. FIG. 8 is a sectional view in an arrow direction of line B-B of FIG. 7. FIG. 9 is a view illustrating a change in a state of the terminal according to the first variation of the embodiment.

The terminal 1A according to the first variation is different from the terminal 1 described above in that a portion of the shape of an outer circumferential wall 7A in a terminal connection unit 2A is different. The terminal 1A is constituted by the terminal connection unit 2A, the coupler 4, and the equipment fixing unit 3, as illustrated in FIG. 5.

The terminal connection unit 2A is constituted by the inner circumferential wall 5, the folded units 6, and the outer circumferential walls 7A.

The outer circumferential walls 7A include outer circumferential wall bodies 20A, four outer circumferential wall contacts 21A, 21A, 22A, and 22A, and extending units 23A.

The outer circumferential wall body 20A is formed along the inner circumferential wall 5 in the circumferential direction from the folded unit 6, and is formed to cover a portion of an outer circumferential face of the inner circumferential wall 5.

The outer circumferential wall contacts 21A, 21A, 22A, and 22A are formed to protrude to the insertion space 13 through the though-holes 15, 15, 16, and 16, and come into contact with the counterpart terminal 50 in an insertion state where the counterpart terminal 50 has been inserted into the terminal connection unit 2A. The two outer circumferential wall contacts 21A and 21A are provided on a side in the removal direction X2 of the outer circumferential walls 7A, and are formed in positions that are symmetrical in the width direction Y with the axis XO as a central axis when viewed in the height direction Z. The two outer circumferential wall contacts 22A and 22A are provided on a side in the insertion direction X1 of the outer circumferential walls 7A, and are formed in positions that are symmetrical in the width direction Y with the axis XO as a central axis when viewed in the height direction Z.

All of the outer circumferential wall contacts 21A, 21A, 22A, and 22A are formed in such a way that a sectional shape when viewed in the axial direction X is bent toward the insertion space 13, as illustrated in FIG. 8. The outer circumferential wall contacts 21A, 21A, 22A, and 22A come into contact with the counterpart terminal 50, and press the counterpart terminal 50 due to elastic deformation of the outer circumferential walls 7A, in the insertion state where the counterpart terminal 50 has been inserted into the terminal connection unit 2A. All of the outer circumferential wall contacts 21A, 21A, 22A, and 22A come into line contact with the counterpart terminal 50 in the axial direction X in the insertion state described above.

In the outer circumferential wall contacts 21A and 21A, when viewed in the axial direction X in a non-insertion state where the counterpart terminal 50 has not been inserted into the terminal connection unit 2A, ends that will come into contact with the counterpart terminal 50 are inserted into the through-holes 15 and 15, and portions of the ends protrude as a contact from the inner circumferential face of the inner circumferential wall 5 to a side of the insertion space 13. In the outer circumferential wall contacts 22A and 22A, when viewed in the axial direction X in the non-insertion state described above, ends that will come into contact with the counterpart terminal 50 are inserted into the through-holes 16 and 16, and portions of the ends protrude as a contact from the inner circumferential face of the inner circumferential wall 5 to a side of the insertion space 13.

The extending units 23A are portions that extend from the outer circumferential wall bodies 20A toward one side in the circumferential direction, and extend from the outer circumferential wall contacts 21A, 21A, 22A, and 22A along the inner circumferential wall 5 toward a side that is opposite to a side of the slit side ends 14 in the circumferential direction. Each of the extending units 23A includes through-holes 24 and 25 for each of the outer circumferential walls 7A, as illustrated in FIG. 7. The through-holes 24, 24, 25, and 25 correspond to what are called punching holes for forming the outer circumferential wall contacts 21A, 21A, 22A, and 22A.

The extending unit 23A has a clearance S in the radial direction between the extending unit 23A and the inner circumferential wall 5. Stated another way, the outer circumferential walls 7A are provided on a side that is opposite to a side of the folded units 6 in the circumferential direction of the outer circumferential walls 7A, and form the clearance S between the outer circumferential walls 7A and the inner circumferential wall 5. When the counterpart terminal 50 has been inserted into the terminal connection unit 2A to deviate in a first direction Z1 (to a side of the slit 12), a width L of the slit 12 increases to a width L1, as illustrated in FIGS. 6 and 9. An increase in width of the slit 12 causes the inner circumferential wall 5 to warp outward in the radial direction, but there is the clearance S between the inner circumferential wall 5 and the outer circumferential walls 7A including the extending units 23A, and therefore the outer circumferential walls 7A do not warp in conjunction with the inner circumferential wall 5, and the outer circumferential wall contacts 21A, 21A, 22A, and 22A move to a side of the insertion space 13.

As described above, the terminal 1A according to the first variation exhibits an advantageous effect that is similar to an advantageous effect of the terminal 1 according to the embodiment described above.

Furthermore, in the terminal 1A according to the first variation, the outer circumferential walls 7A have the clearance S between the outer circumferential walls 7A and the inner circumferential wall 5, and therefore the outer circumferential walls 7A do not warp outward in the radial direction in conjunction with the inner circumferential wall 5, and the outer circumferential wall contacts 21A, 21A, 22A, and 22A move to a side of the insertion space 13. Therefore, in the terminal 1A, for example, even if the counterpart terminal 50 has been inserted in an axis deviation state of deviation in the first direction Z1 (to a side of the slit 12), the followability of the outer circumferential wall contacts 21A, 21A, 22A, and 22A relative to the counterpart terminal 50 can be secured.

Furthermore, in the terminal 1A according to the first variation, the outer circumferential walls 7A include the extending units 23A that extend from the outer circumferential wall contacts 21A, 21A, 22A, and 22A along the inner circumferential wall 5 toward a side that is opposite to a side of the slit side ends 14 in the circumferential direction. Therefore, in the terminal 1A, the extending units 23A increase a surface area of the terminal 1A, the heat capacity of the terminal 1A can be increased, and a rise in temperature of the terminal 1A can be avoided at the time of carrying a current.

### Second Variation

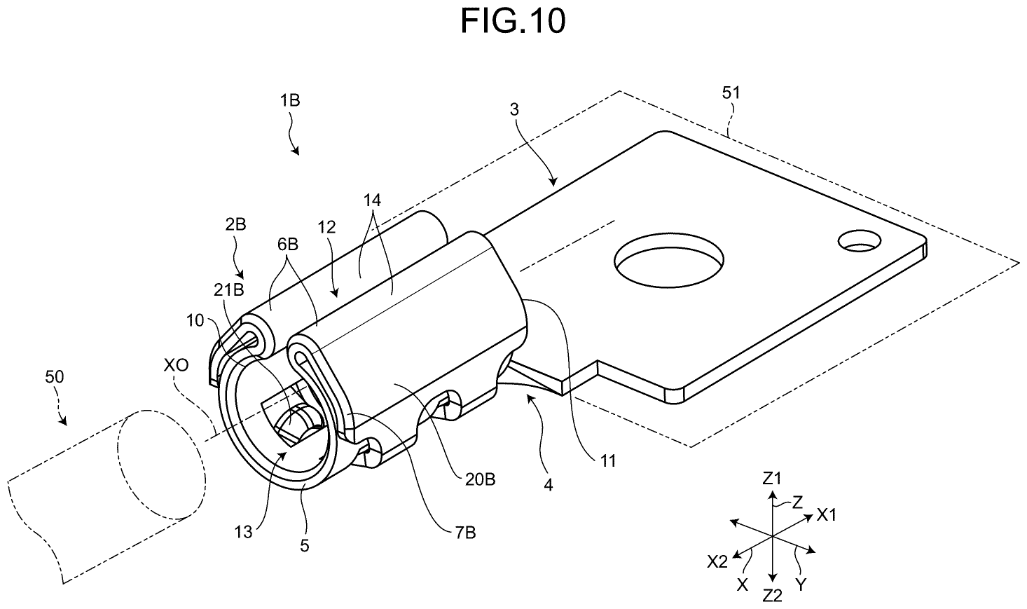

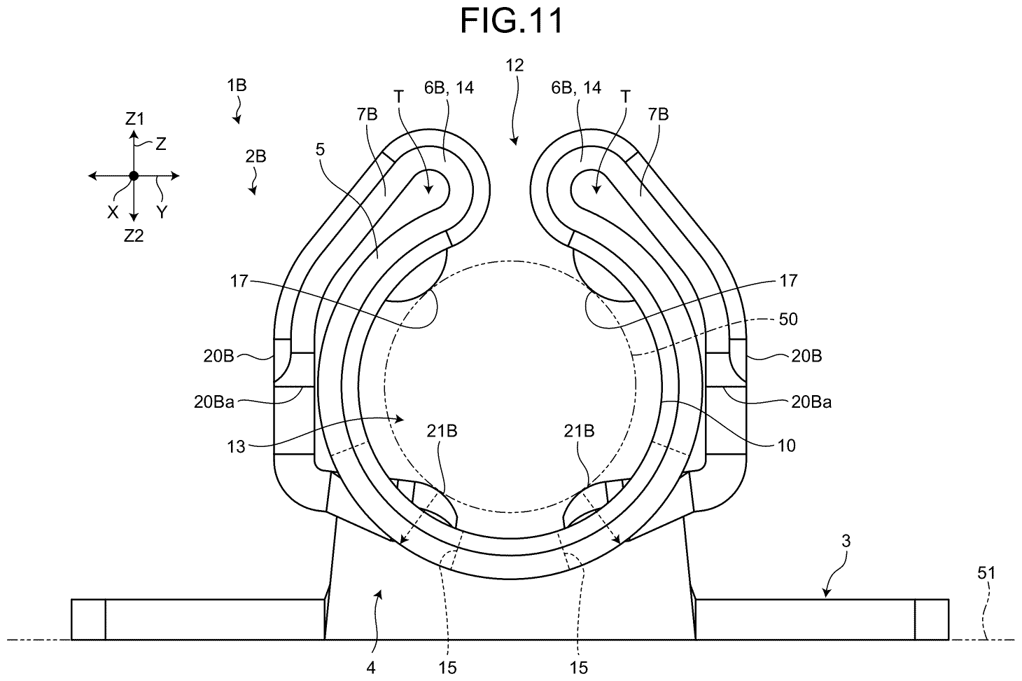

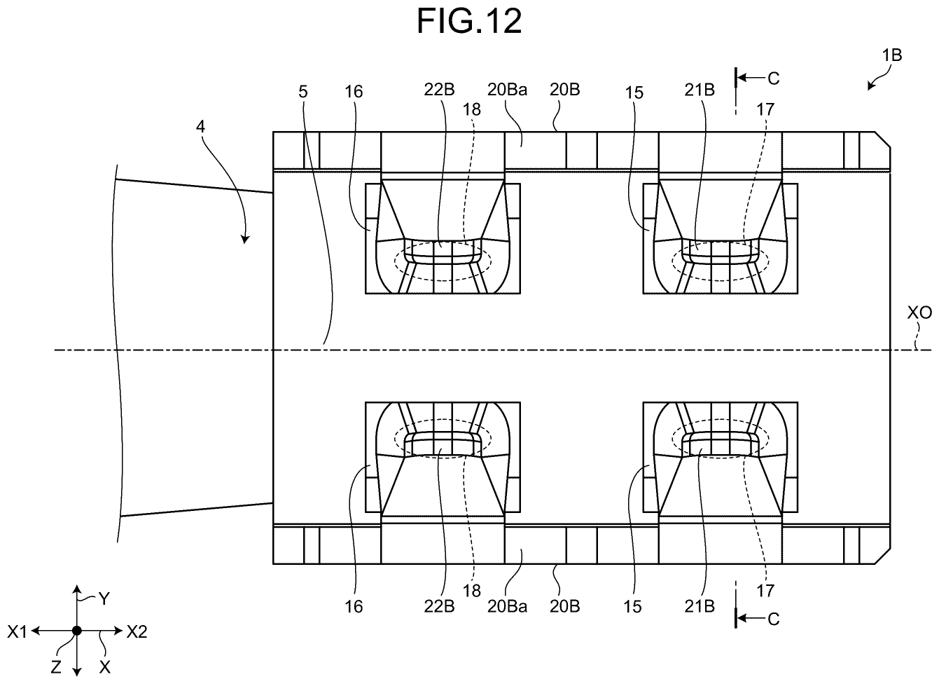

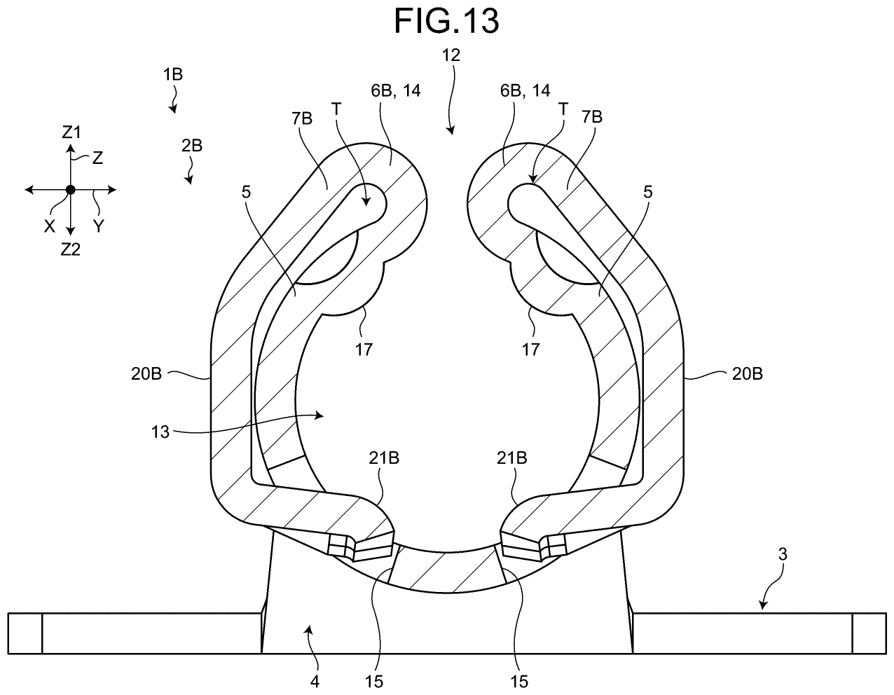

Next, a terminal 1B according to a second variation of the embodiment is described with reference to FIGS. 10 to 13. FIG. 10 is a perspective view illustrating a schematic configuration of a terminal according to the second variation of the embodiment. FIG. 11 is a view illustrating the terminal according to the second variation of the embodiment when viewed in an axial direction. FIG. 12 is a view illustrating a terminal connection unit of the terminal according to the second variation of the embodiment when viewed from a lower side. FIG. 13 is a sectional view in an arrow direction of line C-C of FIG. 12.

The terminal 1B according to the second variation is different from the terminal 1 described above in that an inner diameter of a folded unit 6B and a portion of the shape of an outer circumferential wall 7B in a terminal connection unit 2B are different. The terminal 1B is constituted by the terminal connection unit 2B, the coupler 4, and the equipment fixing unit 3, as illustrated in FIG. 10.

The terminal connection unit 2B is constituted by the inner circumferential wall 5, folded units 6B, and outer circumferential walls 7B.

The folded units 6B are portions that are formed at slit side ends 14 in the circumferential direction around the axis XO of the inner circumferential wall 5, extend inward in the radial direction, and then are folded and bent outward in the radial direction. Stated another way, the folded units 6B have an inner diameter that is relatively larger than an inner diameter of the folded units 6 described above, and have a large clearance T inside.

The outer circumferential walls 7B include outer circumferential wall bodies 20B and four outer circumferential wall contacts 21B, 21B, 22B, and 22B.

The outer circumferential wall bodies 20B are formed along the inner circumferential wall 5 in the circumferential direction from the folded units 6B, and are formed to cover a portion of the outer circumferential face of the inner circumferential wall 5.

The outer circumferential wall contacts 21B, 21B, 22B, and 22B are formed to protrude to the insertion space 13 through the though-holes 15, 15, 16, and 16, and come into contact with the counterpart terminal 50 in an insertion state where the counterpart terminal 50 has been inserted into the terminal connection unit 2B. The two outer circumferential wall contacts 21B and 21B are provided on a side in the removal direction X2 of the outer circumferential walls 7B, and are formed in positions that are symmetrical in the width direction Y with the axis XO as a central axis when viewed in the height direction Z. The two outer circumferential wall contacts 22B and 22B are provided on a side in the insertion direction X1 of the outer circumferential walls 7B, and are formed in positions that are symmetrical in the width direction Y with the axis XO as a central axis when viewed in the height direction Z.

All of the outer circumferential wall contacts 21B, 21B, 22B, and 22B are formed in such a way that a sectional shape when viewed in the axial direction X is bent toward the insertion space 13, as illustrated in FIG. 13. The outer circumferential wall contacts 21B, 21B, 22B, and 22B come into contact with the counterpart terminal 50, and press the counterpart terminal 50 due to elastic deformation of the outer circumferential walls 7B, in the insertion state where the counterpart terminal 50 has been inserted into the terminal connection unit 2B. All of the outer circumferential wall contacts 21B, 21B, 22B, and 22B according to the second variation are formed to have a face of contact to the counterpart terminal 50 that is a semispherical face (or a curved face), as illustrated in FIGS. 10 to 13. Accordingly, the outer circumferential wall contacts 21B, 21B, 22B, and 22B come into point contact with the counterpart terminal 50 without coming into line contact in the axial direction X in the insertion state described above, in contrast to the embodiment described above and the first variation.

As described above, the terminal 1B according to the second variation exhibits an advantageous effect that is similar to an advantageous effect of the terminal 1 according to the embodiment described above.

Furthermore, in the terminal 1B according to the second variation, the folded units 6B extend inward in the radial direction, and then are folded and bent outward in the radial direction. Therefore, the terminal 1B can prevent a crack or the like from being generated in the folded units 6B at the time of 180° bending, even in a case where a relatively hard metal material (for example, a copper alloy or the like instead of native copper) is used.

Note that in the embodiment described above and the first and second variations, the counterpart terminal 50 has been formed into a columnar shape, but is not limited to this, and may be formed into a cylindrical shape.

The terminal according to the present embodiment exhibits an advantageous effect in which a reduction in the number of parts can be achieved.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A terminal comprising:
a terminal connection unit that is formed into a tubular shape in an axial direction, a counterpart terminal being inserted into the terminal connection unit from one opening toward another opening, the terminal connection unit being electrically connected to the counterpart terminal, wherein
the terminal connection unit includes:
an inner circumferential wall that has the tubular shape, and includes a slit that is formed in the axial direction, and an insertion space that communicates with an outside through the slit, the counterpart terminal being inserted into the insertion space from the one opening;
a folded unit that is formed at each of slit side ends in a circumferential direction around an axis of the inner circumferential wall, the folded unit being folded and bent outward in a radial direction that is orthogonal to the axial direction; and
an outer circumferential wall that extends in the circumferential direction along the inner circumferential wall from the folded unit, the outer circumferential wall being formed in an elastically deformable manner to be separated from the inner circumferential wall with the folded unit as a fulcrum,
the inner circumferential wall includes
at least one through-hole that penetrates the inner circumferential wall in the radial direction,
the outer circumferential wall includes
at least one outer circumferential wall contact that is formed to protrude to the insertion space through the through-hole, and
the outer circumferential wall contact performs
coming into contact with the counterpart terminal and pressing the counterpart terminal due to elastic deformation of the outer circumferential wall, in an insertion state where the counterpart terminal has been inserted into the terminal connection unit.

2. The terminal according to claim 1, wherein
the counterpart terminal is
formed into a columnar shape or a cylindrical shape,
the terminal connection unit is
formed into a cylindrical shape, and
the inner circumferential wall includes
at least one inner circumferential wall contact that protrudes toward the insertion space, is formed in a position that faces the outer circumferential wall contact in the radial direction across the axis in the axial direction, and comes into contact with the counterpart terminal in the insertion state.

3. The terminal according to claim 1, wherein
the outer circumferential wall
is provided on a side that is opposite to a side of the folded unit in the circumferential direction of the outer circumferential wall, and forms a clearance between the outer circumferential wall and the inner circumferential wall in the insertion state.

4. The terminal according to claim 2, wherein
the outer circumferential wall
is provided on a side that is opposite to a side of the folded unit in the circumferential direction of the outer circumferential wall, and forms a clearance between the outer circumferential wall and the inner circumferential wall in the insertion state.

5. The terminal according to claim 1, wherein
the outer circumferential wall includes
an extending unit that extends from the outer circumferential wall contact along the inner circumferential wall toward a side that is opposite to a side of the slit side ends in the circumferential direction.

6. The terminal according to claim 2, wherein
the outer circumferential wall includes
an extending unit that extends from the outer circumferential wall contact along the inner circumferential wall toward a side that is opposite to a side of the slit side ends in the circumferential direction.

7. The terminal according to claim 1, further comprising:
an equipment fixing unit that is fixed and electrically connected to equipment; and
a coupler that couples the equipment fixing unit to the inner circumferential wall.
